(19) United States
(12) Patent Application Publication
(10) Pub. No.: US 2005/0195805 A1
(43) Pub. Date: Sep. 8, 2005

(54) Traffic distribuiton method and traffic distribution system of IP key telephone

(75) Inventors: Hidehiko Hanaoka, Tokyo (JP); Daiji Yagi, Tokyo (JP); Masanori Inui, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: IWATSU ELECTRIC CO., LTD., Tokyo (JP)

(21) Appl. No.: 10/855,645

(22) Filed: May 28, 2004

(30) Foreign Application Priority Data
Mar. 8, 2004 (JP) 2004-063715

(51) Int. Cl. H04L 12/66

(52) U.S. Cl. 370/356

(57) ABSTRACT

To implement a key telephone system through an IP (Internet protocol) network, if real-time broadcast information is transmitted by multicast communications, restriction to prevent a rapid increase in network traffic is received, an additional special protocol is required, and it is hard to ensure the confidentiality of information. If real-time broadcast information is transmitted by unicast communications, transmission processing is centralized on a broadcast information transmission apparatus, the traffic becomes enormous, and a broad communication band and a high processing capability become necessary. Therefore, a transmission dedicated apparatus is provided between a broadcast information transmission apparatus and a terminal for distributing the transmission function and traffic. The broadcast information transmission apparatus needs only to manage the transmission dedicated apparatus. A plurality of terminals, etc., can be connected to the transmission dedicated apparatus. Further, a transmission dedicated apparatus can also be connected as a subordinate node to the transmission dedicated apparatus.

### BACKGROUND OF THE INVENTION

1. Field of the Invention

This invention relates to a traffic distribution method and a traffic distribution system of an IP key telephone which implement a key telephone system through an IP (Internet protocol) network.

2. Description of the Related Art

FIG. 11 is a block diagram to show the configuration of a multicast communication system disclosed in JP-A-2003-32300. This system implements a multicast data communication system having advanced security for preventing a problem of generating a large number of meaningless tables in network nodes by attack of a malicious user or the like.

In the multicast data communication system, each of reception hosts 222-1 to 222-4 sends a reception request packet to a transmission host 200 at regular time intervals. A relay node 221 receiving the reception request packet and then receiving a transmission table generation packet and a data packet from the transmission host 200 prepares a transmission table to the transmission host 200 if the transmission table does not exist, and then registers the addresses of the reception hosts 222-1 to 222-4 and the arrival times of the reception request packets and sends a reception request packet to the transmission host 200 at regular time intervals. The relay node 221 receiving a data packet from the transmission host 200 copies and transmits the data packet only to the reception host corresponding to the arrival time of the reception request packet registered in the transmission table being within a given time from the arrival time of the data packet.

Generally, in the case of transmitting broadcast information in real time from a broadcast information transmission apparatus through the IP network to a key telephone system, the following problems are encountered. For example, in order to execute multicast communications disclosed in JP-A-2003-32300, it becomes necessary to add protocols such as DVMRP (Distance-Vector Multicast Routing Protocol) of protocol RFC 1075 for constructing a multicast tree and IGMP (Internet Group Management Protocol) of protocol RFC 1112 (paragraph [0003] in JP-A-2003-32300). Then, a communication network containing components such as routers connected through the IP network must be managed, namely, a communication network management problem (problem 1) is involved. The IGMP is a protocol to control a host group formed for receiving transmission in IP multicast for efficiently transmitting the same data to a plurality of hosts. The protocol is used to transfer information concerning the group between multicast routers, such as participating or withdrawing one host in or from the group.

The communication network management problem (problem 1) in the multicast communications will be further discussed. If multicast transmission is conducted, communication protocol restriction on the network is received. That is, in the general IP network, a multicast packet cannot be through a router and thus it also becomes necessary to change the setting of the router to execute the multicast communications. However, if the setting is changed, a multicast packet flies around to each network separated by the router and the traffic is increased rapidly. Thus, usually the network manager does not permit such router setting change and therefore restriction on execution of the multicast communications (namely, communication cannot be conducted through the router) occurs.

If the network manager permits transmission from a specific multicast transmission source and approves router setting change, it becomes necessary to change the settings of all routers involved in relay. Since the IP network is constructed intricately like meshes, it is extremely difficult to always manage the setting of each router with no mistakes. If the setting management is erroneous, the possibility of occurrence of a leak of secret information to a network outside the transmission range is large and load on the management is large. If a multicast packet is transmitted via a router outside management of ISP (Internet service provider), setting change is made impossible.

In the IP network of the backbone network, generally a precaution against a sudden increase in traffic caused by a rapid increase in communication amount is taken to ensure stable communications. Thus, there is a problem of a sudden increase in traffic (problem 2), namely, multicast communications of simultaneously sending the same communication contents from one communication party (broadcast information transmission apparatus) to a plurality of communication parties (key telephone systems) are hard to use in the IP network because of involving a sudden increase in traffic of the IP network spread like meshes.

Further, since the same information is simultaneously sent (broadcast) to a plurality of communication parties (key telephone systems) in the multicast communications, the possibility that the communication contents will also be leaked to third parties (personal computer, router, server, framework, etc.,) connected to the IP network other than concerned parties in the multicast communications is large and confidentiality is hard to hold, namely, a secret information leak problem (problem 3) is involved.

Further, in the multicast communications, essentially the information flow from a superior node (for example, broadcast information transmission apparatus) to subordinate nodes (for example, terminals) is managed and thus it is difficult to deal with different requests for broadcast information, made by a large number of subordinate nodes in detail and there is an information flow problem (problem 4) of being hard to send information to the superior node.

In contrast to the multicast communications of simultaneously broadcasting the same communication contents from one communication party (broadcast information transmission apparatus) to a plurality of communication parties (key telephone systems), unicast communications of separately sending the same communication contents (broadcast information) from one communication party (broadcast information transmission apparatus) to other communication parties (key telephone systems) are available. There is also a large problem in the unicast communications.

When broadcast information is transmitted in the unicast communications, one broadcast information transmission apparatus transmits the broadcast information to a large number of destinations (key telephone systems) at the same time and thus there is a transmission processing centralization problem (problem 5), namely, the transmission processing is centralized on the broadcast information transmission apparatus of the superior node and load on the broadcast information transmission apparatus becomes large. Further, since the broadcast information is transmitted to a large number of destinations (key telephone systems) at the same time, the traffic also becomes enormous in the IP network and there is a traffic amount increase problem (problem 6) of receiving traffic amount restriction. Also, there is a broadband and high transmission processing capability problem (problem 7), namely, transmission processing cannot be accomplished unless a broadcast information transmission apparatus having a sufficiently broad communication band and a high transmission processing capability is used.

JP-A-2003-32300 is referred to as a related art.

As mentioned above, the multicast communications disclosed in JP-A-2003-32300 has the communication network management problem (problem 1), the problem of a sudden increase in traffic (problem 2), the secret information leak problem (problem 3), the information flow problem (problem 4). The unicast communications has the transmission processing centralization problem (problem 5), the traffic amount increase problem (problem 6), and the broadband and high transmission processing capability problem (problem 7).

### SUMMARY OF THE INVENTION

An object of the invention is to solve the problems described above. Basically, while the features of the unicast communications not involving the problems of the multicast communications are utilized, the problems of the unicast communications (problems 5, 6, and 7) are solved and the broadband and high transmission processing capability problem is also solved by circumventing transmission processing centralization and traffic amount increase by distributing transmission processing.

In A traffic distribution system according to the invention, a transmission dedicated apparatus is provided between a broadcast information transmission apparatus and a destination (key telephone system). The destination information data concerning the area that the transmission dedicated apparatus takes charge of is stored in the transmission dedicated apparatus, the data is accessed, a transmission function to the destination is provided, a node management function for connection to the broadcast information transmission apparatus in a superior node and connection to the area to which the destination in a subordinate node (for example, key telephone system) belongs is provided, and a LAN interface for transferring information (message) transferred between the broadcast information transmission apparatus and the destination (key telephone system) and connection to an IP network is provided.

Accordingly, the need for the broadcast information transmission apparatus to be involved in details of destinations is eliminated. Information exchange between the broadcast information transmission apparatus and the transmission dedicated apparatus is placed only in the extremely limited range and the transmission dedicated apparatus takes charge of information exchange with each destination. Accordingly, the load on the broadcast information transmission apparatus is distributed to the transmission dedicated apparatus and is decreased, leading to solution to the above-described problems.

According to the traffic distribution method and system of an IP key telephone of the invention, the transmission dedicated apparatus is provided between the broadcast information transmission apparatus and a destination (key telephone system), so that it is made possible to distribute the function by the transmission dedicated apparatus. Since the invention is embodied based on the unicast communications not involving the problems of the multicast communications, the above-described problems of the multicast communications (problems 1, 2, 3, and 4) are not involved. Moreover, to eliminate the drawbacks of the unicast communications, namely, the transmission processing centralization problem in the superior node (problem 5), the traffic amount increase problem (problem 6), and the broadband and high transmission processing capability problem (problem 7), transmission processing is distributed to a subordinate node, transmission processing centralization and traffic amount increase are circumvented, and the broadband and high transmission processing capability problem is also solved. Accordingly, the IP key telephone system connected through the IP network is made possible.

### BRIEF DESCRIPTION OF THE DRAWINGS

FIG. 1 is a block diagram to show a traffic distribution method and system of an IP key telephone according to a first embodiment of the invention;

FIGS. 2A and 2B are drawings of subordinate node information stored in a broadcast information transmission apparatus and a transmission dedicated apparatus of components in FIG. 1;

FIG. 3 is a block diagram to show the internal configuration of the transmission dedicated apparatus of the main part of the invention, one component in FIG. 1;

FIG. 4 is a block diagram to show a traffic distribution method and system of an IP key telephone according to a second embodiment of the invention;

FIGS. 5A, 5B and 5C are drawings of subordinate node information stored in a broadcast information transmission apparatus and a transmission dedicated apparatus of components in FIG. 4;

FIG. 6 is a network block diagram to show a traffic distribution method and system of an IP key telephone according to a third embodiment of the invention;

FIG. 7 is a setting description drawing of superior agent, stored in transmission dedicated apparatus R1 and R2 and terminals K1A, K1B, K2A, and K2B in FIG. 6;

FIG. 8 is a sequence diagram of registration message processing in the network configuration in FIG. 6;

FIGS. 9A, 9B and 9C are registration description drawings of subordinate node destination information data stored in broadcast information transmission apparatus Si and the transmission dedicated apparatus R1 and R2 in FIG. 6;

FIG. 10 is a sequence diagram of transmission message processing to provide information notification in the network configuration in FIG. 6; and

FIG. 11 is a block diagram to show the configuration of a network in a related art.

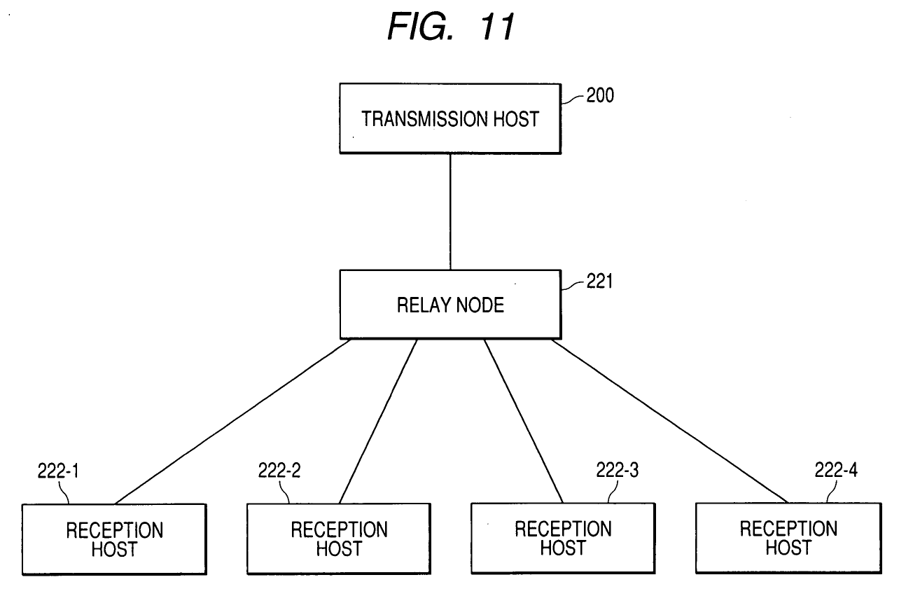

### DETAILED DESCRIPTION OF THE PREFERRED EMBODIMENTS

On the basis of taking the advantages of unicast communications, a transmission dedicated apparatus is provided between a broadcast information transmission apparatus and a terminal of a destination (key telephone system) for distributing the function. That is, unicast communications are conducted between the broadcast information transmission apparatus and the transmission dedicated apparatus, between the transmission dedicated apparatus and another transmission dedicated apparatus of a subordinate node, and between the transmission dedicated apparatus and the terminal.

In the description that follows, SIP (session initiation protocol, communication control protocol used with IP telephone, etc., RFC 3261, RFC 3265) of IP (Internet protocol) proposed by IETF (Internet Engineering Task Force) is used. RFC 3261 is a basic protocol of SIP and RFC 3265 is a protocol defining details of registration (SUBSCRIBE) and information notification (NOTIFY).

### First Embodiment

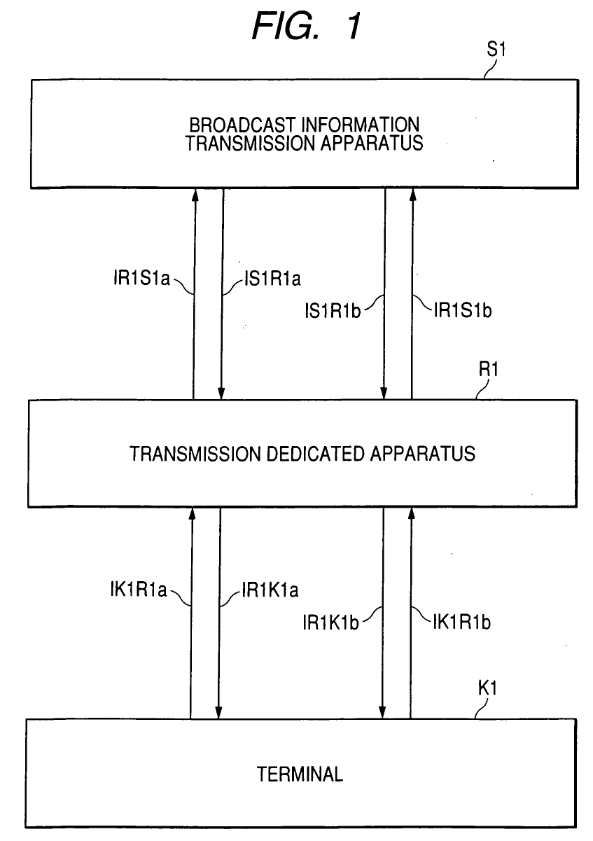

FIG. 1 is a block diagram of a first embodiment of the invention to show the basic configuration of the invention. A broadcast information transmission apparatus S1, a transmission dedicated apparatus R1, and a terminal K1 are provided, and broadcast information is transmitted by means of unicast communications. The transmission dedicated apparatus R1 has the effect of distributing and decreasing load on the broadcast information transmission apparatus S1 in the superior node on which traffic is centralized. Subordinate node registration messages IK1R1a and IR1S1a, subordinate node registration acknowledge messages IS1R1a and IR1K1a, information notification messages IS1R1b and IR1K1b, and information notification acknowledge messages IK1R1b and IR1S1b are transmitted between these apparatuses (S1, R1, K1).

The subordinate node registration message is information to register (subscribe) an apparatus in a subordinate node in an apparatus in a superior node. The subordinate node registration acknowledge message is information (Acknowledge Subscription: Receipt for subscription) issued from the apparatus in the superior node acknowledging that subordinate node registration is complete to the apparatus in the subordinate node. The information notification message (notify) is provided for sending broadcast transmission information (broadcast contents) from the apparatus in the superior node to the apparatus in the subordinate node. The information notification acknowledge message is sent from the apparatus in the subordinate node to the apparatus in the superior node to inform the apparatus in the superior node that the broadcast transmission information has been received (Acknowledge Notification: Receipt for notify).

The operation in FIG. 1 is as follows. Upon reception of a subordinate node registration message IK1R1a for requesting broadcast transmission from the terminal K1 in the subordinate node connected to the node of the transmission dedicated apparatus R1, the transmission dedicated apparatus R1 sends a subordinate node registration message IR1S1a for requesting broadcast transmission to the broadcast information transmission apparatus S1 in the superior node. Upon reception of the message, the broadcast information transmission apparatus S1 registers (subscribes) the transmission dedicated apparatus R1 and prepares for the information to be transmitted. Then, the broadcast information transmission apparatus S1 sends a subordinate node registration acknowledge message IS1R1a to the transmission dedicated apparatus R1 as a receipt, informing the transmission dedicated apparatus R1 that the registration is complete. The transmission dedicated apparatus R1 prepares for the information to be transmitted. Then, the transmission dedicated apparatus R1 sends a subordinate node registration acknowledge message IR1K1a to the terminal K1, informing the terminal K1 that the registration is complete.

After completion of the registration, the broadcast information transmission apparatus S1 transmits specified broadcast information to the transmission dedicated apparatus R1 with an information notification message IS1R1b at regular time intervals. The transmission dedicated apparatus R1 stores the broadcast information transmitted with the information notification message IS1R1b and at the same time, sends an information notification acknowledge message IR1S1b to the broadcast information transmission apparatus S1, informing the broadcast information transmission apparatus S1 that the information notification message IS1R1b has been received. The transmission dedicated apparatus R1 transmits the stored broadcast information to the terminal K1 with an information notification message IR1K1b at regular time intervals. Upon reception of the broadcast information, the terminal K1 sends an information notification acknowledge message IK1R1b to the transmission dedicated apparatus R1, informing the transmission dedicated apparatus R1 that the information notification message IR1K1b has been received.

As the operation is performed as described above, unicast communications are conducted for transmission between the broadcast information transmission apparatus Si and the transmission dedicated apparatus R1 and the transmission dedicated apparatus R1 transmits the stored broadcast information to the terminal K1 with the information notification message IR1K1b at regular time intervals, so that the traffic and transmission processing centralized on the superior node (broadcast information transmission apparatus S1) in the related art can be distributed to the subordinate node (transmission dedicated apparatus R1).

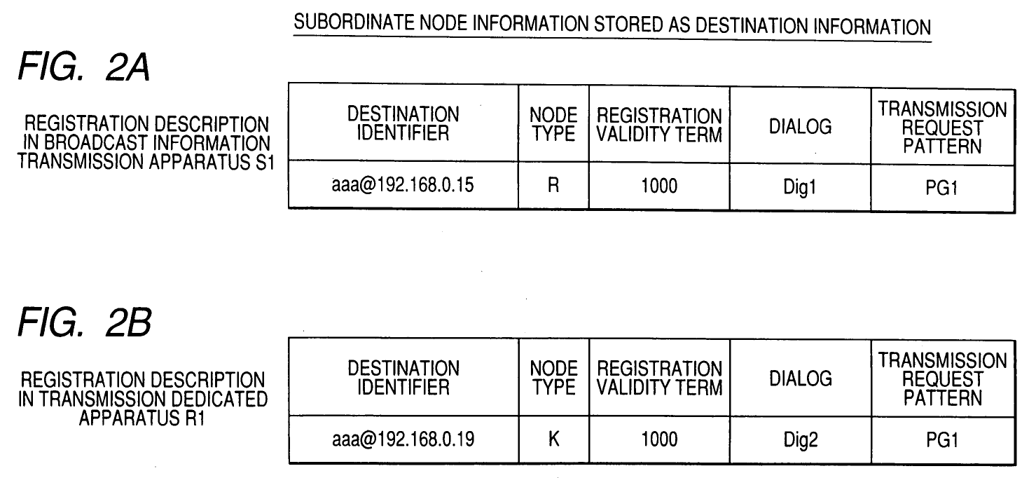

FIGS. 2A and 2B are destination information drawings to represent an example of subordinate node information stored as destination information in the broadcast information transmission apparatus S1 and the transmission dedicated apparatus R1 of the components in FIG. 1. In FIGS. 2A and 2B, the identifiers of the destinations (R1 and K1) for determining destinations, the node types (R and K) representing the types of apparatus at destinations, the validity term (for example, the number of days) to register the transmission information, the dialog mode (Dig1, Dig2), and transmission request pattern representing pattern of transmitted broadcast information (PG1) are stored.

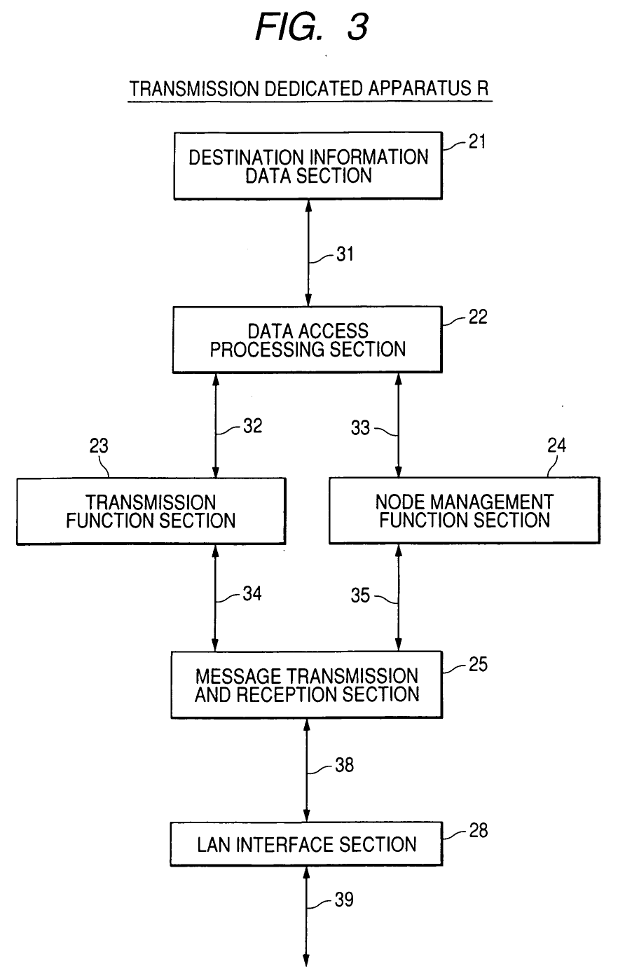

FIG. 3 shows the internal configuration of the transmission dedicated apparatus R of the main part of the invention. The transmission dedicated apparatus R includes a destination information data section 21, a data access processing section 22, a transmission function section 23, a node management function section 24, a message transmission and reception section 25, and a LAN interface section 28.

The destination information data section 21 has a function of recording information concerning a subordinate node and a transmission request pattern indicating what broadcast information is requested by the subordinate node (FIGS. 2A and 2B) . The data access processing section 22 has a function of executing data registration, deletion, update, search, or reference in a unified way. The transmission function section 23 has a function of instructing the message transmission and reception section 25 to execute message transmission of broadcast information to subordinate node based on the destination information data. The node management function section 24 has a function of analyzing a message received by the message transmission and reception section 25, adding, deleting, or updating a superior or subordinate node, and instructing the message transmission and reception section 25 to transmit a response message indicating that registration has been executed.

The message transmission and reception section 25 has a function of receiving a message through the LAN interface section 28, analyzing the message according to the protocol, passing the processing result to the node management function section 24, and transmitting a message according to the protocol based on transmission processing information received from the transmission function section 23. The LAN interface section 28 is connected to other nodes (the broadcast information transmission apparatus S1 and the terminal K1) through the IP network by an information transmission line 39 and has a function of interfacing with the message transmission and reception section 25.

A destination information input/output signal 31 is transmitted between the destination information data section 21 and the data access processing section 22. A destination search and reference signal 32 is transmitted between the data access processing section 22 and the transmission function section 23. An information control signal 33 is transmitted between the data access processing section 22 and the node management function section 24. A transmission instruction signal 34 is transmitted between the transmission function section 23 and the message transmission and reception section 25. A broadcast information signal 35 is transmitted between the node management function section 24 and the message transmission and reception section 25. A transmission-reception signal 38 is transmitted between the message transmission and reception section 25 and the LAN interface section 28. The LAN interface section 28 is connected to other nodes (the broadcast information transmission apparatus S1, subordinate transmission dedicated apparatus R2, and the terminal K1) through the IP network by the information transmission line 39.

The destination information input/output signal 31 is a signal for executing registration, deletion, update, search, or reference input/output of the destination information data shown in FIGS. 2A and 2B. The destination search and reference signal 32 is a signal for searching for or referencing the broadcast information transmission destination. The information control signal 33 is a signal for controlling registration, deletion, and update of destination information or transmission information. The transmission instruction signal 34 is a signal for instructing the message transmission and reception section 25 to transmit the broadcast information specified by the transmission function section 23.

The broadcast information signal 35 is a signal for transferring the broadcast information received by the message transmission and reception section 25 through the IP network from the broadcast information transmission apparatus S1 to the node management function section 24. The transmission-reception signal 38 is a signal for transmitting and receiving information through the LAN interface section 28. The information transmission line 39 connects the transmission dedicated apparatus R to other nodes (the broadcast information transmission apparatus S1, subordinate transmission dedicated apparatus R2, and the terminal K1) through the IP network.

### Second embodiment

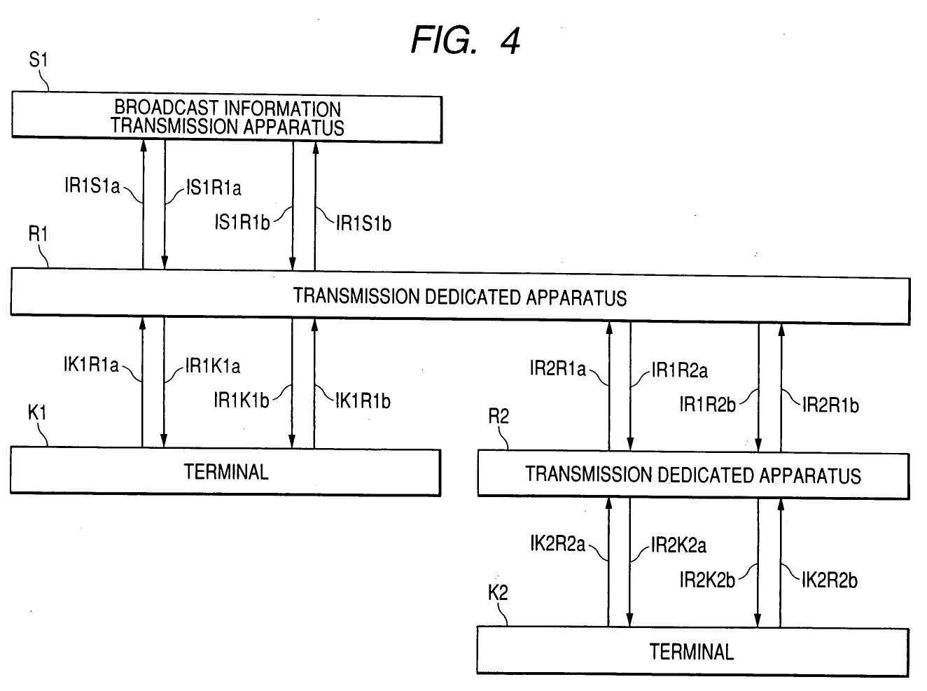

FIG. 4 is a block diagram to show a second embodiment of the invention. Components identical with or similar to those previously described with reference to FIG. 1 are denoted by the same reference numerals in FIG. 4. A broadcast information transmission apparatus S1, a transmission dedicated apparatus R1, and a terminal K1 are provided. A transmission dedicated apparatus R2 is connected to the transmission dedicated apparatus R1, and a terminal K2 is connected to the transmission dedicated apparatus R2. The configuration in FIG. 4 differs from the configuration in FIG. 1 in that the transmission dedicated apparatus R2 takes charge of transmission to the terminal K2 for decreasing load on the transmission dedicated apparatus R1. That is, the transmission dedicated apparatus R1 has the effect of decreasing load on the broadcast information transmission apparatus S1 in the superior node, and the transmission dedicated apparatus R2 has the effect of decreasing load on the transmission dedicated apparatus R1 in the superior node.

Subordinate node registration messages IK1R1a, IR1S1a, IK2R2a, and IR2R1a, subordinate node registration acknowledge messages IS1R1a, IR1K1a, IR1R2a, and IR2K2a, information notification messages IS1R1b, IR1K1b, IR1R2b, and IR2K2b, and information notification acknowledge messages IK1R1b, IR1S1b, IK2R2b, and IR2R1b are transmitted between these apparatuses (S1, R1, K1, R2, K2).

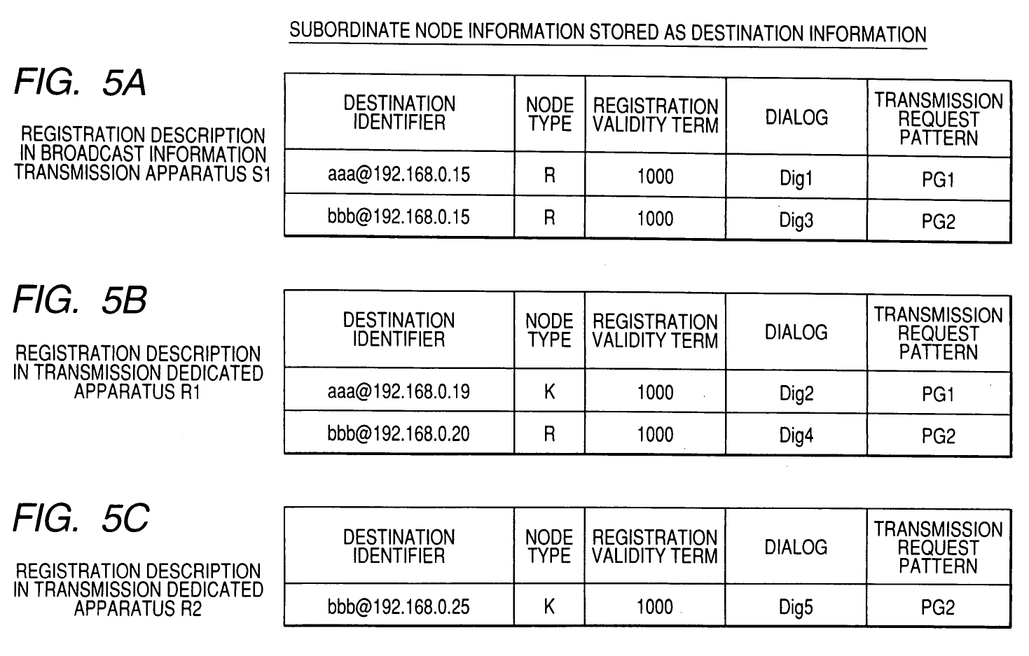

FIGS. 5A, 5B and 5C show subordinate node information stored as destination information in the broadcast information transmission apparatus S1 and the transmission dedicated apparatus R1 and R2 of the components in FIG. 4. The registration description in the broadcast information transmission apparatus S1 shown in FIG. 5A, the identifiers of the transmission dedicated apparatus R1 and R2 are registered under the destination identifier. The apparatus types of transmission dedicated apparatus R1 and R2 are registered under the node type. How many days the registration is valid in the transmission dedicated apparatus R1 and R2 is registered under the registration validity term. The dialog modes used for the transmission dedicated apparatus R1 and R2 are registered under the dialog. The transmission request patterns showing the types of broadcast information to be transmitted to the transmission dedicated apparatus R1 and R2 are registered under the transmission request pattern. The registration description in each of the transmission dedicated apparatus R1 and R2 shown in FIGS. 5B and 5C is similar to the registration description in the broadcast information transmission apparatus S1 shown in FIG. SA.

### Third Embodiment

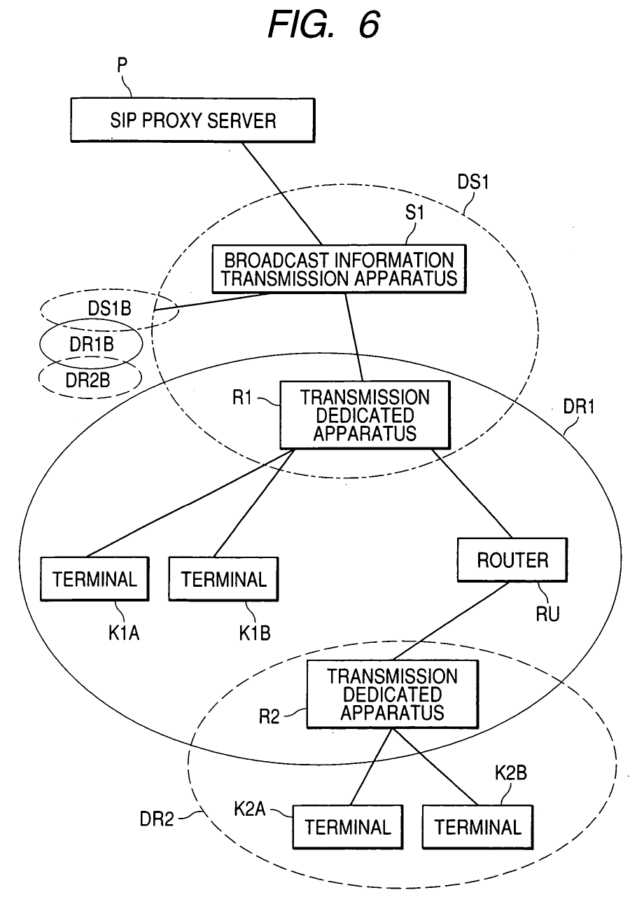

FIG. 6 is a network block diagram to show a traffic distribution method and system of an IP key telephone according to a third embodiment of the invention. An SIP proxy server P, a broadcast information transmission apparatus S1, and transmission dedicated apparatus R1 and R2 are provided, and transmission target ranges DS1, DS1B, DR1, DR1B, DR2, and DR2B are shown. The SIP proxy server P receives an SIP request from a terminal K or another SIP proxy server and transfers the SIP request to the broadcast information transmission apparatus S1 or acts as proxy of the broadcast information transmission apparatus S1. The broadcast information transmission apparatus S1 transmits information to the transmission dedicated apparatus R1 contained in the transmission target range DS1. The transmission dedicated apparatus R1 transmits information to two terminals K1A and K1B contained in the transmission target ranges DR1 and the transmission dedicated apparatus R2 connected through a router RU for relay. The transmission dedicated apparatus R2 transmits information to two terminals K2A and K2B contained in the transmission target ranges DR2. The functions of the components are the same as those previously described with reference to FIG. 4.

Use of the two transmission dedicated apparatus R1 and R2 makes it possible to decrease load on the transmission dedicated apparatus R1 and distribute the processing capability of the transmission dedicated apparatus R1. To furthermore decrease the load and distribute the processing capability, it is also possible to provide a transmission dedicated apparatus R3 (not shown) in a subordinate node to the transmission dedicated apparatus R2. As a transmission dedicated apparatus R in a subordinate node is added, it is made possible to upsize the system while the load on the superior node is minimized. Further, transmission target range DS1B, DR1B, DR2B, etc., can be added to the broadcast information transmission apparatus S1 as required.

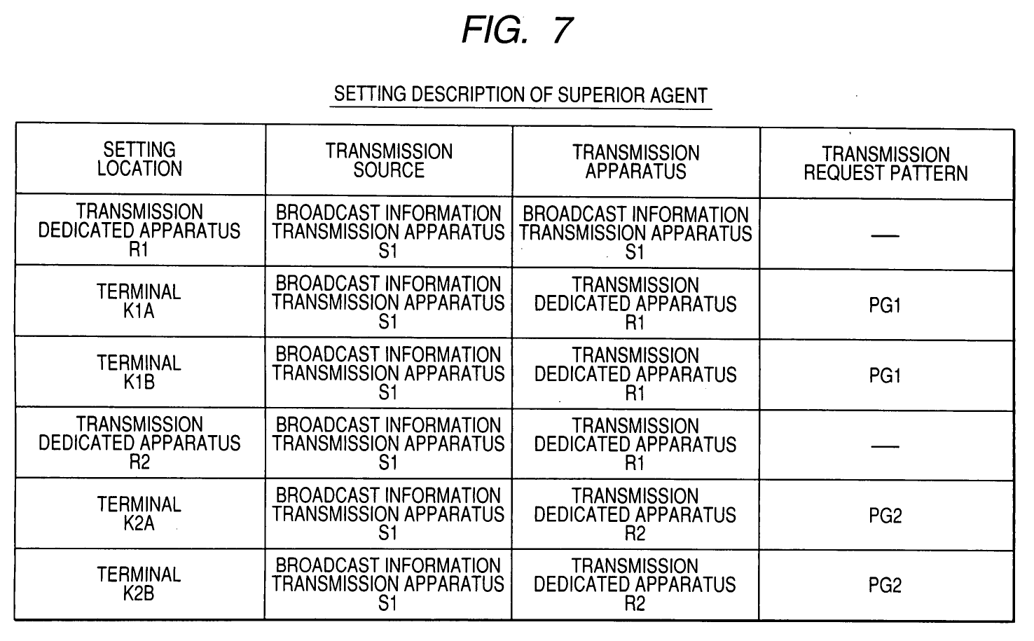

FIG. 7 is a registration setting description drawing concerning superior agent (node), stored in the transmission dedicated apparatus R1 and R2 and the terminals K1A, K1B, K2A, and K2B in FIG. 6. The registration in the transmission dedicated apparatus R1 indicates that the transmission source is the broadcast information transmission apparatus S1 and that the transmission apparatus directly connected to the transmission dedicated apparatus R1 is the broadcast information transmission apparatus S1. The registration in each of the terminal K1A and K1B indicates that the transmission source is the broadcast information transmission apparatus S1 and that the transmission apparatus directly connected to the terminal K1A, K1B is the transmission dedicated apparatus R1. The terminals K1A and K1B register the transmission request pattern (PG1) in the transmission dedicated apparatus R1. Therefore, the transmission dedicated apparatus R1 transmits only the already registered transmission request pattern (PG1) of the transmission information transmitted from the broadcast information transmission apparatus S1 to the terminals K1A and K1B.

The registration in the transmission dedicated apparatus R2 indicates that the transmission source is the broadcast information transmission apparatus S1 and that the transmission apparatus directly connected to the transmission dedicated apparatus R2 is the transmission dedicated apparatus R1. The registration in each of the terminal K2A and K2B indicates that the transmission source is the broadcast information transmission apparatus S1 and that the transmission apparatus directly connected to the terminal K2A, K2B is the transmission dedicated apparatus R2. The terminals K2A and K2B register the transmission request pattern (PG2) in the transmission dedicated apparatus R2. Therefore, the transmission dedicated apparatus R2 transmits only the already registered transmission request pattern (PG2) of the transmission information transmitted through the transmission dedicated apparatus R1 from the broadcast information transmission apparatus S1 to the terminals K2A and K2B.

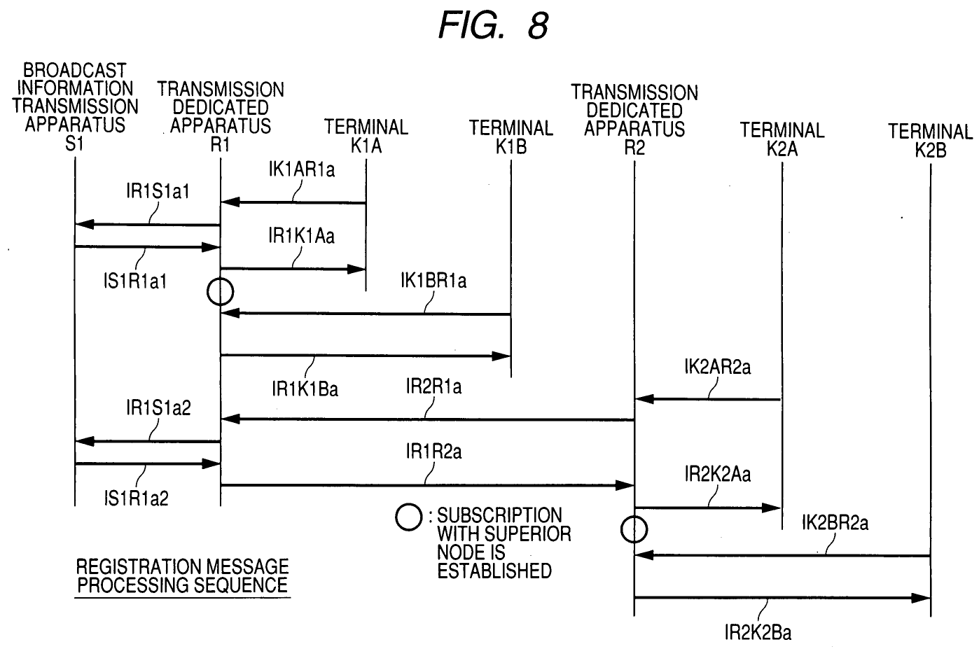

The case where using SIP (RFC 3261, RFC 3265), each subordinate node is registered using a SUBSCRIBE message and broadcast information is transmitted using a NOTIFY message will be discussed with FIGS. 8, 9, and 10. The specific detailed description of the subscribe and notify messages is given in SIP (RFC 3265/draft-ietf-simple-presence-07.txt) and therefore only the main part is shown in the description to follow.

FIG. 8 shows a registration message processing sequence in the network configuration in FIG. 6 the broadcast information transmission apparatus S1 as the superior node is already registered (subscribed) to the transmission dedicated apparatus R1 for transmission between them. The transmission dedicated apparatus R1 in the superior node is already registered to the transmission dedicated apparatus R2 for transmission between them.

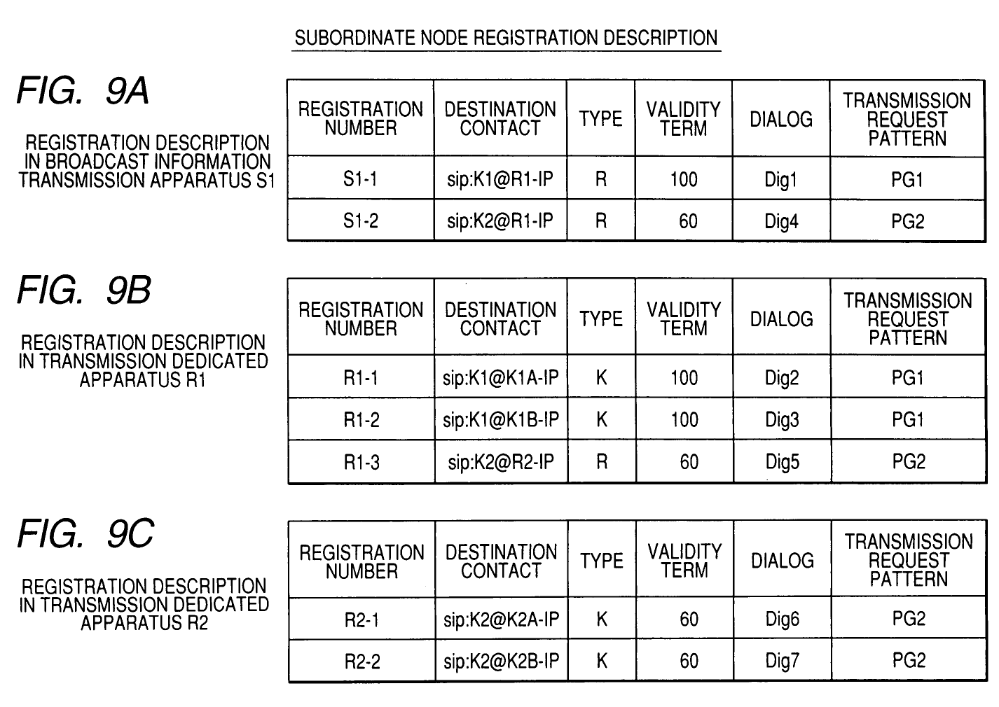

A subordinate node registration message IK1AR1a called subscribe for making a request for registering (subscribing to) transmission is issued from the terminal K1A in the subordinate node to the transmission dedicated apparatus R1. The subordinate node registration message IK1AR1a contains the transmission request information pattern (PG1) and node information of the terminal K1A (K1@K1A-IP), which is registered as destination contact (registration number R1-1 in FIG. 9B).

Upon reception of the message, the transmission dedicated apparatus R1 sends a subordinate node registration message IR1S1a1 called subscribe to the broadcast information transmission apparatus (presence agent) S1. The subscribe message contains the transmission request information pattern (PG1) and node information of the transmission dedicated apparatus R1 (K1@R1-IP), which is registered as destination contact (registration number S1-1 in FIG. 9A). The broadcast information transmission apparatus S1 accomplishes registration and sends a subordinate node registration acknowledge message IS1R1a1 to the transmission dedicated apparatus R1, which then informs the terminal K1A that registration of the terminal K1A is complete.

That is, the transmission dedicated apparatus R1 is registered in the broadcast information transmission apparatus S1 based on the subordinate node registration message IR1S1a1 and the subordinate node registration acknowledge message IS1R1a1. Registration of the terminal K1A is accomplished in the transmission dedicated apparatus R1 based on the subordinate node registration message IK1AR1a and a subordinate node registration acknowledge message IR1K1Aa. Accordingly, the transmission dedicated apparatus R1 establishes subscription with the superior node (broadcast information transmission apparatus S1) (transmission registration is complete).

Subsequently, a subordinate node registration message IK1BR1a called subscribe message for making a request for registering (subscribing to) transmission is issued from the terminal K1B in the subordinate node to the transmission dedicated apparatus R1. Upon reception of the message, the transmission dedicated apparatus R1 checks on destination information data to see if the transmission request information pattern (PG1) contained in the subscribe message is already stored for the terminal K1. If it is unregistered, it is registered in the transmission dedicated apparatus R1 (registration number R1-2). In this registration (registration number R1-2 in FIG. 9B), destination information data containing the destination contact (sip:K1@K1B-IP), the node type (K), the subscribe validity term (for example, 100 seconds), and the transmission request information pattern (PG1) is stored.

At the same time, a subordinate node registration acknowledge message IR1K1Ba is sent to the terminal K1B and registration of the terminal K1B is complete. Registration of the transmission dedicated apparatus R1 in the broadcast information transmission apparatus S1 is already complete based on the subordinate node registration message IR1S1a1 and the subordinate node registration acknowledge message IS1R1a1. That is, the transmission dedicated apparatus R1 establishes subscription with the broadcast information transmission apparatus S1 in the superior node.

Likewise, a subordinate node registration message IK2AR2a (subscribe message) is issued from the terminal K2A to the transmission dedicated apparatus R2. The subscribe message contains the transmission request information pattern (PG2) and node information of the terminal K2A (K2@K2A-IP), which is registered as destination contact (registration number R2-1). The transmission dedicated apparatus R2 accomplishes registration and sends a subordinate node registration message IR2R1a to the transmission dedicated apparatus R1 as a subscribe message.

Then, since the transmission request pattern (PG2) of the terminal K2A differs from the already stored pattern (PG1), the transmission dedicated apparatus R1 accomplishes registration of the transmission dedicated apparatus R2 (registration number R1-3) and transmits a subordinate node registration message IR1S1a2 to the broadcast information transmission apparatus S1 as a subscribe message setting the transmission request pattern (PG2) and node information of the transmission dedicated apparatus R1 (K2@R1-IP). Upon reception of the subordinate node registration message IR1S1a2 as a subscribe message, the broadcast information transmission apparatus S1 stores the destination contact to transmit broadcast information (sip:K2@R1-IP), the node type (R), the validity term (for example, 60 seconds), the dialog (Dig4) specifying the dialog mode, and the transmission request pattern (PG2) as destination information data (registration number S1-2).

At the same time as storing the destination information data, the broadcast information transmission apparatus S1 transmits a subordinate node registration acknowledge message IS1R1a2A2 to the transmission dedicated apparatus R1. Upon reception of the message, the transmission dedicated apparatus R1 validates registration of the transmission dedicated apparatus R2 (registration number R1-3) and immediately transmits a subordinate node registration acknowledge message IR1R2a to the transmission dedicated apparatus R2. Upon reception of the message, the transmission dedicated apparatus R2 validates registration of the terminal K2A (registration number R2-1) and transmits a subordinate node registration acknowledge message IR2K2Aa to the terminal K2A. Accordingly, the transmission dedicated apparatus R2 establishes subscription with the superior node (broadcast information transmission apparatus S1) (contacts with the superior node for transmission).

Subsequently, a subordinate node registration message IK2BR2a for making a request for registering transmission as a subscribe message is issued from the terminal K2B in the subordinate node to the transmission dedicated apparatus R2. Upon reception of the registration request, the destination contact (sip:K2@K2B-IP), the node type (K), the validity term (for example, 60 seconds), the dialog (Dig7) of the dialog mode, and the transmission request pattern (PG2) are registered in the transmission dedicated apparatus R2 (registration number R2-2). Since the transmission dedicated apparatus R2 has already established subscription with the transmission dedicated apparatus R2 (superior node) for the transmission request pattern (PG2), the registration (registration number R2-2) is validated immediately and a subordinate node registration acknowledge message IR2K2Ba is sent to the terminal K2B. Registration of the terminal K2B is complete. Registration of the transmission dedicated apparatus R2 in the broadcast information transmission apparatus S1 is already complete based on the subordinate node registration messages IR2R1a and IR1S1a2 and the subordinate node registration acknowledge messages IS1R1a2 and IR1R2a.

FIGS. 9A, 9B and 9C show the subordinate node registration description registered in subordinate nodes as the result of the registration message processing in FIG. 8. The subordinate nodes to the broadcast information transmission apparatus S1 are registered in (a), the subordinate nodes to the transmission dedicated apparatus R1 are registered in (b), and the subordinate nodes to the transmission dedicated apparatus R2 are registered in (c). The registration in the registration numbers S1-1 and S1-2 is as follows: The identifiers of the transmission dedicated apparatus R1 and R2 are registered under the destination contact; the transmission dedicated apparatus R under the type; 100 seconds and 60 seconds, for example, under the registration validity term; Dig1 and Dig4 under the dialog (dialog mode); and PG1 and PG2 under the transmission request pattern.

In FIG. 9B, the registration numbers R1-1 to R1-3 of the subordinate nodes to the transmission dedicated apparatus R1 are included and the registration is as follows: The identifiers of the terminals K1A and K1B and the transmission dedicated apparatus R2 are registered under the destination contact (destination information); two terminals K and one transmission dedicated apparatus R under the type; 100 seconds, 100 seconds, and 60 seconds, for example, under the registration validity term; Dig1, Dig3, and Dig5 under the dialog (dialog mode); and PG1, PG1, and PG2 under the transmission request pattern.

In FIG. 9C, the registration numbers R2-1 and R2-2 of the subordinate nodes to the transmission dedicated apparatus R2 are included and the registration is as follows: The identifiers of the terminals K2A and K2B are registered under the destination contact (destination information); two terminals K under the type; 60 seconds and 60 seconds, for example, under the registration validity term; Dig6 and Dig7 under the dialog (dialog mode); and PG2 and PG2 under the transmission request pattern.

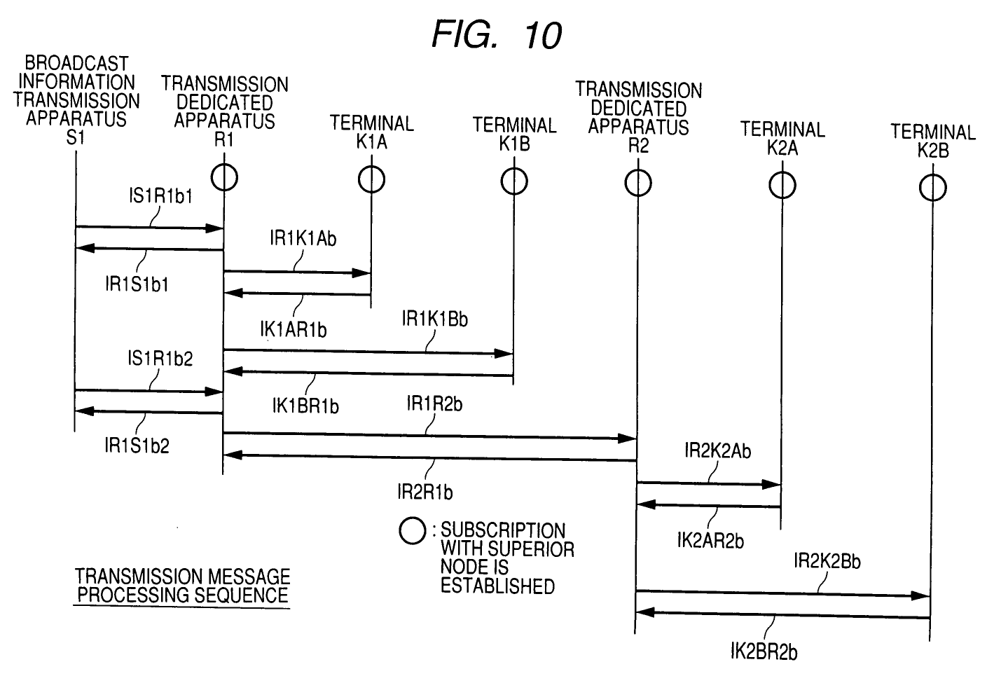

FIG. 10 shows a transmission message processing sequence in the network configuration in FIG. 6. In FIGS. 9A-9C, the transmission dedicated apparatus R1 is already registered in the broadcast information transmission apparatus S1 of the presence agent. Then, an information notification message IS1R1b1 called NOTIFY is sent to the transmission dedicated apparatus R1. The information notification message IS1R1b1 contains notify message setting the transmission request patterns (PG1 and PG2) of the destination contacts (sip:K1@R1-IP and sip:K2@R1-IP) of the destination information data registered in the registration numbers S1-1 and S1-2 in FIG. 9A. Upon reception of the message, the transmission dedicated apparatus R1 sends an information notification acknowledge message IR1S1b1 to the broadcast information transmission apparatus S1 to inform the broadcast information transmission apparatus S1 that the message has been received. Upon reception of the information notification acknowledge message IR1S1b1, the broadcast information transmission apparatus S1 stops resending the notify message to the transmission dedicated apparatus R1.

The transmission dedicated apparatus R1 stores the contents of the transmission request patterns (PG1 and PG2) in the notify message received with the information notification message IS1R1b1 as the destination information data. The transmission dedicated apparatus R1 sends notify messages setting transmission information (PG1 to K1A and K1B and PG2 to R2) to the destination contacts (sip:K1@K1A-IP, sip:K1@K1B-IP, and sip:K2@R2-IP, registration numbers R1-1, R1-2, and R1-3 in FIG. 9B) stored as the destination information data at regular time intervals as it sends information notification messages IR1K1Ab, IR1K1Bb, and IR1R2b to the terminals K1A and K1B and the transmission dedicated apparatus R2.

Upon reception of the messages, the terminals K1A and K1B and the transmission dedicated apparatus R2 send information notification acknowledge messages IK1AR1b, IK1BR1b, and IR2R1b to the transmission dedicated apparatus R1 to inform the transmission dedicated apparatus R1 that the messages have been received. Upon reception of the information notification acknowledge messages, the transmission dedicated apparatus R1 stops resending the notify messages to the terminals K1A and K1B and the transmission dedicated apparatus R2. The terminals K1A and K1B display reception of the transmission information (PG1).

The transmission dedicated apparatus R2 stores the transmission information according to the transmission pattern (PG2) in the notify message received with the information notification message IR1R2b as destination information data. When already stored transmission information exists, it is updated with the most recent transmission information (PG2). The transmission dedicated apparatus R2 sends notify messages setting transmission information (PG2) to the destination contacts (sip:K2@K2A-IP and sip:K2@K2B-IP, registration numbers R2-1 and R2-2 in FIG. 9C) stored as the destination information data at regular time intervals as it sends information notification messages IR2K2Ab and IR2K2Bb to the terminals K2A and K2B.

Upon reception of the messages, the terminals K2A and K2B send information notification acknowledge messages IK2AR2b and IK2BR2b to the transmission dedicated apparatus R2 to inform the transmission dedicated apparatus R2 that the messages have been received. Upon reception of the information notification acknowledge messages IK2AR2b and IK2BR2b, the transmission dedicated apparatus R2 stops resending the notify messages. The terminals K2A and K2B display reception of the transmission information (PG2).

According to the multicast communications in the related art example, in FIG. 6, the transmission dedicated apparatus R1 and R2 do not exist and the broadcast information transmission apparatus S1 transmits information collectively to the terminals K1A, K1B, K2A, and K2B by multicast communications. That is, the communication network management problem (problem 1), the problem of a sudden increase in traffic (problem 2), and the secret information leak problem (problem 3) in the multicast communications described above are involved. As shown in FIGS. 9A-9C, according to the invention, any desired information can be transmitted in any desired format separately to each of the terminals K1A, K1B, K2A, and K2B according to their respective transmission requests and dialogs (dialog modes).

In contrast, according to the multicast communications in the related art, the broadcast information transmission apparatus S1 transmits the same information in the same format collectively to the terminals K1A, K1B, K2A, and K2B, and the information transmitted to the terminals K1A and K1B is also transmitted to the terminals K2A and K2B desiring transmission of different information. That is, the secret information leak problem (problem 3) and the information flow problem (problem 4) of being unable to transmit necessary information only to the necessary locations in the multicast communications described above arise. In contrast, in the invention, the problems do not arise.

In the unicast communications in the related art, the transmission processing centralization problem (problem 5) described above arises. According to the invention, the broadcast information transmission apparatus S1 and the transmission dedicated apparatus R1 and R2 take charge of their respective transmission target ranges DS1, DR1, and DR2 and transmit information separately to the terminals K1A, K1B, K2A, and K2B by unicast communications, so that the transmission processing centralization problem (problem 5) does not arise.

The broadcast information transmission apparatus S1 and the transmission dedicated apparatus R1 and R2 take charge of their respective transmission target ranges DS1, DR1, and DR2. Separate unicast communications occurring here occur in the transmission target ranges DS1, DR1, and DR2 in a transmission manner, so that the traffic amount increase problem (problem 6) described above does not arise either in the invention. Further, the broadcast information transmission apparatus S1 and the transmission dedicated apparatus R1 and R2 take charge of their respective transmission target ranges DS1, DR1, and DR2 for transmitting information, so that the broadband and high transmission processing capability problem (problem 7) described above does not arise either in the invention. The advantages will be easily understood from the description previously given with reference to FIG. 6.

1. A traffic distribution method of an IP key telephone, comprising:
a broadcast information transmission step of transmitting broadcast information to be transmitted through an Internet protocol network to a subordinate node;
a first transmission dedicated step of transmitting the broadcast information transmitted in said broadcast information transmission step to only a subordinate node; and
at least one of a reception step of receiving the broadcast information transmitted in said first transmission dedicated step, and a second transmission dedicated step of transmitting the broadcast information transmitted in said first transmission dedicated step to a subordinate node upon reception of a transmission instruction from said first transmission dedicated step.

2. The traffic distribution method according to claim 1,
wherein said first transmission dedicated step includes:
a destination information data step of storing destination information data showing a subordinate node to where the broadcast information is transmitted;
a data access step of inputting/outputting the destination information data stored in the destination information data step;
a transmission function step of processing to transmit a message regarding transmission of the broadcast information to the subordinate node based on the destination information data;
a message transmission and reception step of transmitting and receiving a message to and from the subordinate node, and analyzing a reception message in accordance with a predetermined protocol; and
a node management function step of analyzing a message received in the by the message transmission and reception step to manage the subordinate node.

3. A traffic distribution system of an IP key telephone, comprising:
a broadcast information transmission portion which transmits broadcast information to be transmitted through an Internet protocol network to a subordinate node thereof;
a first transmission dedicated portion which transmits the broadcast information transmitted from said broadcast information transmission portion to only a subordinate node thereof; and
at least one of a terminal portion which receives the broadcast information transmitted from said first transmission dedicated portion, and a second transmission dedicated portion which transmits the broadcast information transmitted from said first transmission dedicated portion to a subordinate node upon reception of a transmission instruction from said first transmission dedicated portion.

4. The traffic distribution system according to claim 3,
wherein said first transmission dedicated portion includes:
a destination information data portion which stores destination information data showing a subordinate node to where the broadband information is transmitted;
a data access portion which inputs/outputs the destination information data stored in said destination information data portion;
a transmission function portion which processes to transmit a message regarding transmission of the broadcast information to the subordinate node based on the destination information data;
a message transmission and reception portion which transmits and receives a message to and from the subordinate node, and analyzes a reception message in accordance with a predetermined protocol; and
a node management function portion which analyzes a message received by said message transmission and reception portion to manage the subordinate node.

5. The traffic distribution system according to claim 3,
wherein said second subordinate node transmission dedicated portion transmits the broadcast information to a subordinate node lower than said second subordinate node transmission dedicated portion.

6. The traffic distribution system according to claim 3,
wherein said broadcast information transmission portion transmits the broadcast information to only said first transmission dedicated portion.

7. The traffic distribution system according to claim 3,
wherein in a case of that said second transmission dedicated portion is included in the subordinate nodes of said first transmission dedicated portion,
said first transmission dedicated portion does not transmit the broadcast information to the subordinate node of said second transmission dedicated portion.
